(19) United States
(12) Patent Application Publication
(10) Pub. No.: US 2006/0103165 A1
(43) Pub. Date: May 18, 2006

(54) Protective vehicle cover and method of use

(76) Inventor: Thomas T. Ward, Clarksville, VA (US)

Correspondence Address: MICHAEL R. PHILLIPS, P.O. BOX 1818, TOMS RIVER, NJ, 08754-1818, US

(21) Appl. No.: 10/987,974

(22) Filed: Nov. 12, 2004

(51) Int. Cl. B60J 7/20

(52) U.S. Cl. 296/136.02; 296/136.07

(57) ABSTRACT

A protective cover (20) for a vehicle (10) having horizontally oriented transverse chambers (22) and vertically oriented chambers (24) made of an exterior sheet (42) and an interior sheet (42a) connected to one another by a series of separators (44). The horizontal and vertical chambers (22, 24) are connected to each other by corner chambers (28) and end chambers (38) oriented lengthwise of the vehicle cover (20) to convey pressurized air throughout the cover (20). The cover (20) has an inlet air valve (34) and an outlet air port (36). A number of anchor connecting loops (30) are provided to connect the cover (20) to the vehicle (10) by a number of straps (40).

### RELATED APPLICATION

This application is a conversion of and claims benefit of Provisional Patent Application No. 60/508,194 filed Oct. 2, 2003.

### FIELD OF THE INVENTION

The present invention relates to the field of vehicle covers, and more particularly to vehicle covers that are inflatable to provide a cushioned cover for protecting a vehicle from falling objects, particularly hailstones.

### BACKGROUND OF THE INVENTION

Millions of dollars are wasted annually in the repetitive exercise of repairing automobiles and other vehicles that have sustained hailstorm damage. A large amount of damage is done to vehicles by hailstones. Hailstones can be as large as four inches in diameter, impacting vehicle surfaces at velocities of up to one hundred miles an hour or more. Hailstones cause damage to both the body panels and the glass of vehicles. Many types of vehicles are susceptible to hail damage, including passenger automobiles, trucks, motor homes and airplanes. The only protection currently available to the vehicle owner is to park the vehicle under a solid-roof structure which, in many instances, is not available. While insurance companies frequently pay for repairs, the cost is ultimately borne by the vehicle owner and all automobile insurance customers in the form of higher insurance premiums. In addition to the cost involved, the vehicle owner has to contend with the inconvenience of having to arrange for the repair and obtain temporary alternate transportation.

The incidence of hailstorms has been increasing in recent years as the global weather patterns have been changing. Due to global warming and other climatic conditions, most areas that are prone to hail have seen a 400%-500% increase in the average number of hail days over the last 20 years. Many weather forecast services are predicting that the number of annual hailstorm events will increase in future years.

Conventional, non-inflatable vehicle covers are available for protecting vehicles from exposure to the weather, particularly sun and precipitation. These ordinary vehicle covers provide little or no protection against falling objects. In addition, certain inflated covers have been developed that can protect a vehicle from small falling objects like small hail or acorns. Examples of such cushioned vehicle covers are found in U.S. Pat. No. 5,242,206 to Heck, U.S. Pat. No. 5,350,000 to Wang, and U.S. Pat. No. 5,890,525 to Shores. Each of these prior patents describes a vehicle cover that has a plurality of chambers that are filled with air to form a resilient cushion that is intended to prevent falling objects from damaging the vehicle surface, and are described below.

The U.S. Pat. No. 5,242,206 discloses an automobile hail blanket having an inflatable upper portion and a non-inflatable bottom portion, with straps connecting therebetween. This blanket is adapted to draw pressurized air from the automobile's tires to inflate the upper portion.

The U.S. Pat. No. 5,350,000 provides an inflatable multi-air-bag cover for cars. Each of the multiple air bags is disposed across the width of a car and is connected to adjacent air bags through a pressure-controlled valve. When a first air bag is inflated to a pre-set pressure, an air valve opens between the inflated air bag and an adjacent non-inflated air bag, allowing the pressurized air to enter the adjacent air bag.

The U.S. Pat. No. 5,890,525 describes an inflatable car cover having multiple air compartments that are oriented laterally on the horizontal surfaces of the car and longitudinally on the vertical surfaces thereof. A series of inflatable straps are connected to the cover. Inflation of all compartments occurs through a sealable air valve.

Although several inflatable vehicle covers are known through the patents noted above, the present invention provides a more practical and distinctive cover having a number of novel features, and overcoming the deficiencies of the prior art.

### SUMMARY OF THE INVENTION

The protective vehicle cover of the invention is formed of an exterior sheet and an interior sheet of resin-coated fabric connected to one another with coated fabric separators that are welded in spaced apart positions to form a number of chambers. A horizontal wall of these chambers and two vertical walls of these chambers are connected to each other with a pair of longitudinal corner chambers and a pair of longitudinal end chambers so that air can pass throughout the cover when being inflated.

The cover is fitted with a series of anchor connecting loops spaced around its lower edge. A strap is connected to each loop and to the vehicle before inflating the cover so that the increase in cover size caused by inflation tightens the straps to hold the cover securely in place.

The cover has an inlet air valve with a self-sealing flap to prevent air from escaping. The cover also has an outlet air port to deflate the cover rapidly when desired.

The present invention is best understood in conjunction with the accompanying drawing figures in which like elements are identified by similar reference numerals and wherein:

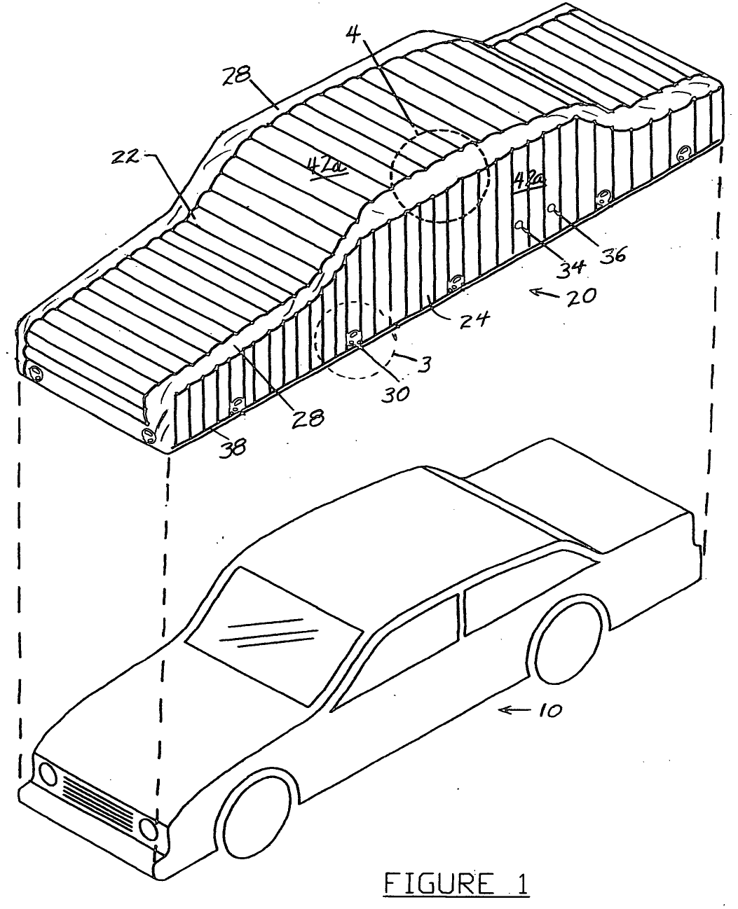

FIG. 1 is a perspective view of a vehicle with an inflated protective cover of the present invention shown above the vehicle for clarity.

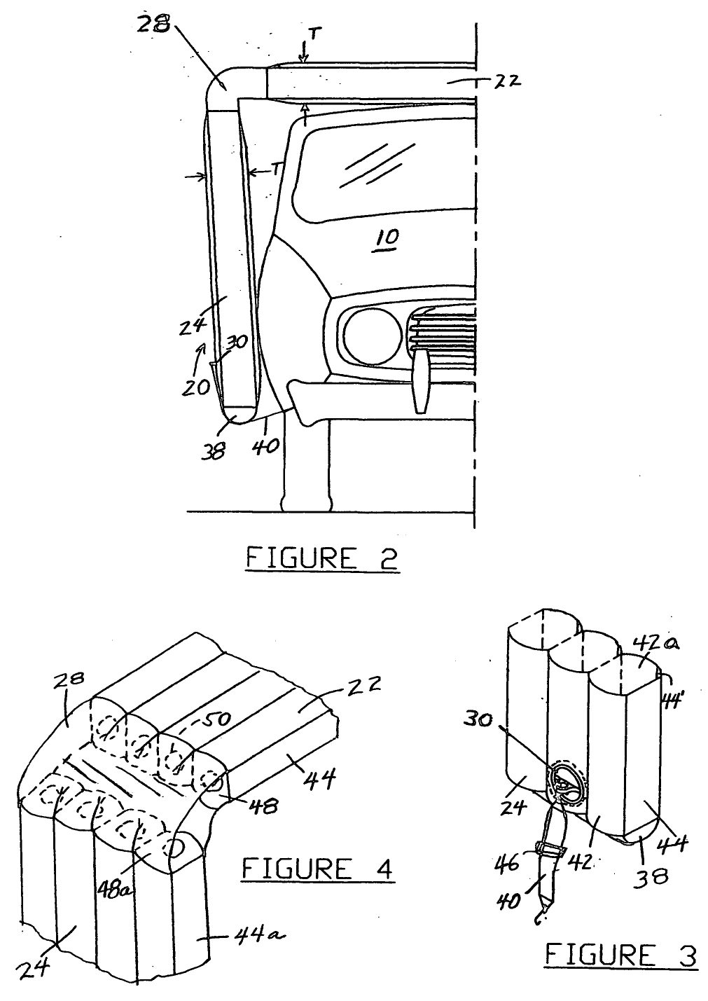

FIG. 2 is a front elevation view of a half of the vehicle with a typical section of the protective cover assembled thereon.

FIG. 3 is an enlarged perspective view of the portion of the invention vehicle cover within circle 3 of FIG. 1 to show a typical anchor connection loop.

FIG. 4 is an enlarged perspective view of the portion of the invention in circle 4 of FIG. 1 to show the transition from the top wall to a side wall of the protective cover.

### DETAILED DESCRIPTION OF THE PREFERRED EMBODIMENT

FIG. 1 depicts a protective vehicle cover 20 in inflated condition and suspended above a vehicle 10, for example a passenger car. As will be understood from the description below, the present invention vehicle cover is adaptable to various types of vehicles, such as passenger cars, trucks, motor homes, airplanes and boats, with the cover configured appropriately. Vehicle cover 20 is provided in deflated and folded condition for transport and storage. For use, vehicle cover 20 is first unfolded and placed over vehicle 10, and a series of straps, to be discussed below, are connected to vehicle 10. It is important to place vehicle cover 20 over vehicle 10 with the attachment and inflation fittings on its exterior surface. Through the process of inflation, the straps become taut to secure vehicle cover 20 in place.

Vehicle cover 20 is formed with a series of vertical chambers 24 on each side wall connected to a series of horizontal transverse chambers 22 through left and right longitudinal corner chambers 28. A longitudinal end chamber 38 connects the lower end of each of vertical chambers 24. Thus, air is able to pass throughout longitudinal end chamber 38, vertical chambers 24, longitudinal corner chambers 28 and horizontal transverse chambers 22 to inflate the totality of vehicle cover 20 from a single inlet air valve 34, sealed in place through the exterior wall of one vertical chamber 24. Inlet air valve 34 incorporates an integral check valve flap so that air pressure will be preserved if valve 34 is accidentally left uncovered. An outlet air port 36 is sealed through the exterior wall of a second vertical chamber 24. Outlet air port 36 is a simple opening with a sealable cover, for example a screw cap, to allow air to be discharged quickly from vehicle cover 20 when the hailstone danger has passed and vehicle cover 20 is to be removed.

A series of anchor connecting loops 30 are affixed in spread apart locations adjacent to the lower extremity of vehicle cover 20 on both exterior walls of vertical chambers 24 and the front and rear vertical portions of horizontal transverse chambers 22. Anchor connecting loops 30 are formed with a flange that is larger than the hole through which it is placed for welding to the inside surface of selected chambers for tenacity. Anchor connecting loops 30 are configured to attach a securing strap with a loop or hook.

Referring now to FIG. 2, half of vehicle 10 is illustrated in front elevation view with a cutaway view of vehicle cover 20 as fully assembled in place and inflated. A strap 40 is shown connecting from anchor connecting loop 30 to a member on the bottom surface of vehicle 10, for example a frame member. As noted above, strap 40 is preferably connected to anchor connecting loop 30 and a member of vehicle 10 before vehicle cover 20 is inflated in order that strap 40 is placed in tension as a result of the increase in bulk of vehicle cover 20 that is caused by the inflation process. According to the preferred embodiment of the invention, vehicle cover 20 is sized so that when it is fully inflated at least all horizontal transverse chambers 22, and preferably including all vertical chambers 24, have a thickness T of at least 12.7 cm. (5 inches) or, more preferably, a thickness T of about 16.5 cm. (6.5 inches).

As discussed briefly above, vehicle cover 20 is intended to provide protection for any of the various types of vehicle to which the present invention is applied in fairly severe weather conditions, especially hailstorms. With large hailstones potentially impacting vehicle cover 20 at a velocity of up to 150 km per hour (90 miles per hour) or more, vehicle cover 20 must be resistant to puncture and stretching. A suitable material for vehicle cover 20 is a fabric woven of 70 denier nylon and coated on one side with polyurethane resin to achieve a total weight of approximately 157 g/m² (4.7 oz/yd²).

Whereas vehicle cover 20 may be used in locations where the respective vehicle 10 is not in the vicinity of a garage or other building having electric power, an air pump capable of operating on electric power from the vehicle, i.e. 12 volts D.C., is required. The pump (not shown) will be provided with a power cord of sufficient length to reach from an electric outlet in the vehicle, e.g. the cigarette lighter socket, to inlet air valve 34. The pump will also be operable in wet conditions that often accompany a hailstorm. The pump must be capable of inflating vehicle cover 20 in as short a time as possible, generally not more than 10 minutes, to an inflation pressure of approximately 70 g/cm² (1.0 lb/in²) over atmospheric pressure. The pump delivery hose will be fitted with a connector for secure attachment to inlet air valve 34.

Referring now to FIG. 3, a portion of vehicle cover 20 within circle 3 of FIG. 1 shows the cellular structure of vertical chambers 24. Vertical chambers 24 and horizontal transverse chambers 22 of vehicle cover 20 are formed with an exterior sheet 42 and an interior sheet 42a. A separator 44 is affixed, for example by ultrasonic welding, at selected intervals to exterior sheet 42 and interior sheet 42a to form a series of elongate tubular chambers 24. Separators 44 are welded to the inside surfaces of exterior sheet 42 and interior sheet 42a with lap joints 44′ to form vertical chamber 24. For optimum weld strength, the lap joints are made with the polyurethane coated surface of separator 44 in contact with the polyurethane coated surface of sheets 42 and 42a. Separators 44 serve to control the thickness of vehicle cover 20 when inflated, avoiding a ballooning effect and maintaining the overall shape of vehicle cover 20. Anchor connecting loop 30 is similarly welded to exterior sheet 42 to provide a connecting point for strap 40. Strap 40 is preferably minimally elastic and has an integral length adjustment device, e.g. buckle 46.

FIG. 4 shows a detail of the juncture of vertical chambers 24 and horizontal transverse chambers 22 with longitudinal corner chamber 28. Longitudinal corner chamber 28 is assembled as a transition chamber between horizontal transverse chamber 22 and vertical chamber 24 to allow air to pass and pressure to equalize throughout vehicle cover 20. Longitudinal corner chamber 28 allows an unrestricted flow of air through its entire length and into vertical chambers 24 and horizontal transverse chambers 22. A perforated baffle 48, 48a, formed with one or more holes 50 therethrough, is welded into each end of each of horizontal transverse chamber 22 and vertical chamber 24 (the lower baffle in vertical chambers 24 not shown). Baffles 48 and 48a control ballooning in similar fashion to the function of separators 44 and 44a between adjacent transverse chambers. Adequate open area is provided for the free passage of air through holes 50 to adjacent air chambers during inflation and deflation, while retaining adequate strength to keep the ends of respective transverse chambers from ballooning when under full pressure.

While the description above discloses preferred embodiments of the present invention, it is contemplated that numerous variations and modifications of the invention are possible and are considered to be within the scope of the claims that follow.

What is claimed is:

1. An inflatable and deflatable protective cover for a vehicle, comprising:
a. a plurality of vertically oriented chambers;
b. a plurality of horizontally oriented transverse chambers;
c. a plurality of longitudinal chambers connecting between the vertically oriented and horizontally oriented chambers to convey pressurized air from chambers with higher pressure to chambers with lower pressure; and
d. an air inlet valve extending outwardly from a selected vertically oriented transverse chamber.

2. The protective vehicle cover described in claim 1, wherein the vertically oriented chambers and the horizontally oriented transverse chambers are formed of an exterior sheet and an interior sheet with a plurality of separators connecting therebetween.

3. The protective vehicle cover described in claim 2, further comprising a perforated baffle fixedly assembled at each end of each vertically oriented chamber and each horizontally oriented transverse chamber.

4. The protective vehicle cover described in claim 1, further comprising a sealable outlet air port extending outwardly from a selected vertically oriented chamber.

5. The protective vehicle cover described in claim 1, further comprising a plurality of anchor connecting loops fixedly connected to a plurality of vertically oriented chambers at a lower end thereof.

6. The protective vehicle cover described in claim 1, wherein the horizontally oriented transverse chambers are configured to attain a thickness measured in the vertical direction of at least 12.5 cm (5.0 in).

7. The protective vehicle cover described in claim 1, wherein the horizontally oriented transverse chambers are configured to attain a thickness measured in the vertical direction of approximately 16.5 cm (6.5 in).

8. The protective vehicle cover described in claim 2, wherein the interior and exterior sheets and the separators are formed of a fabric that is coated on at least one side with a resin.

9. The protective vehicle cover described in claim 8, wherein the chambers are formed by welding with the resin coated side of the interior and exterior sheets in contact with the resin coated side of the separators.

10. A method for protecting a vehicle from damage due to falling objects, comprising the steps of:
a. providing an inflatable protective cover for a vehicle having a horizontal wall comprised of multiple chambers and a vertical wall comprised of multiple chambers connected on each side of the horizontal wall to be in fluid communication therewith, the vertical wall having an inlet air valve and an outlet air port connected thereto and a plurality of anchor connecting loops connected thereto in spaced apart locations;
b. positioning the protective cover over the vehicle with the inlet air valve, the outlet air port and the anchor connecting loops extending in a direction outward from the vehicle;
c. attaching a plurality of straps at a first end thereof to the plurality of anchor connecting loops and at a second end thereof to a lower part of the vehicle;
d. connecting a source of pressurized air to the inlet air valve; and
e. pressurizing the chambers of the protective cover by actuating the source of pressurized air to inflate the protective cover and to cause the straps to become taut for securely holding the protective cover to the vehicle.

11. The method described in claim 10, further comprising the step of maintaining the source of pressurized air in operation until the protective cover is inflated to a pressure of approximately 70.0 g/cm² (1.0 lb/in²).

12. The method described in claim 10, wherein the source of pressurized air is maintained in operation until the horizontal wall of the protective cover has a thickness measured in the vertical direction of at least 12.5 cm (5.0 in).

13. The method described in claim 10, wherein the source of pressurized air is maintained in operation until the horizontal wall of the protective cover has a thickness measured in the vertical direction of at least 16.5 cm (6.5 in).

14. The method described in claim 10, further comprising the step of opening the outlet air port to deflate the protective cover.
